(19) United States
(12) Patent Application Publication
(10) Pub. No.: US 2012/0262074 A1
(43) Pub. Date: Oct. 18, 2012

(54) DRIVING CIRCUIT OF LIGHT EMITTING DIODES HAVING AT LEAST ONE BYPASS CIRCUIT, AND DRIVING METHOD THEREOF

(76) Inventors: Wei-Cheng Wang, Taichung City (TW); Bau-Ru Lu, Changhua County (TW); Chun-Hsien Lu, Hsinchu City (TW); Jeng-Jen Li, Taipei City (TW)

(21) Appl. No.: 13/425,412

(22) Filed: Mar. 20, 2012

(30) Foreign Application Priority Data
Apr. 13, 2011 (TW) 100112790

(51) Int. Cl. H05B 37/02

(52) U.S. Cl. 315/186; 315/193

(57) ABSTRACT

A driving circuit of light emitting diodes includes a power supply circuit, at least one bypass circuit, and a temperature control circuit. The power supply circuit is used for providing a driving voltage to at least one series of light emitting diodes. Each bypass circuit of the at least one bypass circuit is used for being turned on when an ambient temperature is lower than a predetermined temperature. The temperature control circuit is coupled to the at least one bypass circuit for detecting the ambient temperature, and sending a control signal to the at least one bypass circuit when the ambient temperature is lower than the predetermined temperature. Therefore, the driving voltage can still drive the at least one series of light emitting diodes when the ambient temperature is lower than the predetermined temperature.

### BACKGROUND OF THE INVENTION

1. Field of the Invention

The present invention relates to a driving circuit of light emitting diodes and a driving method thereof, and particularly to a driving circuit of light emitting diodes and a driving method thereof that have at least one bypass circuit.

2. Description of the Prior Art

In applications of lighting circuits (such as a series of light emitting diodes), a driving voltage provided by a power supply circuit usually approaches a voltage drop of the series of light emitting diodes to reduce loss of the series of light emitting diodes, where the driving voltage is still greater than the voltage drop. However, when the series of light emitting diodes operate at a low temperature environment, because a forward voltage drop of a light emitting diode is inversely proportion to an ambient temperature of the light emitting diode, the driving voltage provided by the power supply circuit may be smaller than the voltage drop of the series of light emitting diodes, resulting in the lighting circuits not operating normally.

Please refer to FIG. 1. FIG. 1 is a diagram illustrating inverse proportionality of a forward voltage drop of a light emitting diode to an ambient temperature of the light emitting diode. As shown in FIG. 1, the forward voltage drop of the light emitting diode decreases with increase of the ambient temperature of the light emitting diode. For example, when the ambient temperature is equal to −25° C., the forward voltage drop of the light emitting diode is 3.6V, and when the ambient temperature is equal to 75° C., the forward voltage drop of the light emitting diode is 3.3V.

Please refer to FIG. 2. FIG. 2 is a diagram illustrating a driving circuit 200 of light emitting diodes according to the prior art. The driving circuit 200 includes a power supply circuit 202 and seven light emitting diodes 204 which are connected in series. The power supply circuit 202 is used for driving the seven light emitting diodes 204. When an ambient temperature is equal to 75° C., a total forward voltage drop of the seven light emitting diodes 204 is equal to 23.1V (7*3.3V=23.1V). However, when the ambient temperature is equal to −25° C., the total forward voltage drop of the seven light emitting diodes 204 is equal to 25.2V (7*3.6V=25.2V). Meanwhile, if a driving voltage Vo provided by the power supply circuit 202 is 24V, the driving circuit 200 can not operate normally, resulting in the seven light emitting diodes 204 not being turned on normally.

To solve the above problem, the prior art usually reduces light emitting diode number of a series of light emitting diodes to reduce a forward voltage drop of the series of light emitting diodes to ensure that the driving circuit can operate normally at a low ambient temperature. However, decreasing the light emitting diode number of the series of light emitting diodes may reduce operation efficiency of a driving circuit for driving the series of light emitting diodes at room temperature. In addition, the prior art can also utilize a previous stage conversion circuit to adjust the driving voltage provided by the power supply circuit to make the driving voltage provided by the power supply circuit always larger than the forward voltage drop of the series of light emitting diodes. However, utilizing the previous stage conversion circuit to adjust the driving voltage provided by the power supply circuit may decrease efficiency of the previous stage conversion circuit. Therefore, decreasing the light emitting diode number of the series of light emitting diodes and utilizing the previous stage conversion circuit to adjust the driving voltage provided by the power supply circuit are not the best choices for a designer of the driving circuit.

### SUMMARY OF THE INVENTION

An embodiment provides a driving circuit of light emitting diodes having at least one bypass circuit. The driving circuit includes a power supply circuit, at least one bypass circuit, and a temperature control circuit. The power supply circuit is used for providing a driving voltage to at least one series of light emitting diodes. Each bypass circuit of the at least one bypass circuit is used for being turned on when an ambient temperature is lower than a predetermined temperature. The temperature control circuit is coupled to the at least one bypass circuit for detecting the ambient temperature, and sending a control signal to the at least one bypass circuit when the ambient temperature is lower than the predetermined temperature.

Another embodiment provides a driving method for controlling at least one bypass circuit of a driving circuit of light emitting diodes. The driving method includes detecting an ambient temperature of a series of light emitting diodes; determining whether the ambient temperature is lower than a predetermined temperature; sending a control signal when the ambient temperature is lower than the predetermined temperature; and turning on at least one bypass circuit to make two terminals of at least one light emitting diode of the series of light emitting diodes short-circuited according to the control signal.

Another embodiment provides a driving circuit of light emitting diodes having at least one bypass circuit. The driving circuit includes a power supply circuit, at least one bypass circuit, and a timer. The power supply circuit is used for providing a driving voltage to at least one series of light emitting diodes. Each bypass circuit of the at least one bypass circuit is used for being turned off after the power supply circuit is powered on for a predetermined time. The timer is used for sending a control signal to the at least one bypass circuit to turn off the at least one bypass circuit after the power supply circuit is powered on for the predetermined time.

Another embodiment provides a driving method for controlling at least one bypass circuit of a driving circuit of light emitting diodes. The driving method includes providing a driving voltage to a series of light emitting diodes; sending a control signal to at least one bypass circuit after the series of light emitting diodes is provided with the driving voltage for a predetermined time; and turning off the at least one bypass circuit according to the control signal.

The present invention provides a driving circuit of light emitting diodes having at least one bypass circuit and a driving method thereof. The driving circuit and the driving method utilize a temperature control circuit to send a control signal to turn on at least one bypass circuit, resulting in at least one light emitting diode of a series of light emitting diodes being turned off, or utilize a timer to send a control signal to turn off at least one bypass circuit, resulting in at least one light emitting diode of the series of light emitting diodes being turned on. Therefore, when an ambient temperature is lower than a predetermined temperature, a driving voltage provided by a power supply circuit can still drive the series of light emitting diodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an inverse proportion of a forward voltage drop of a light emitting diode to an ambient temperature of the light emitting diode.

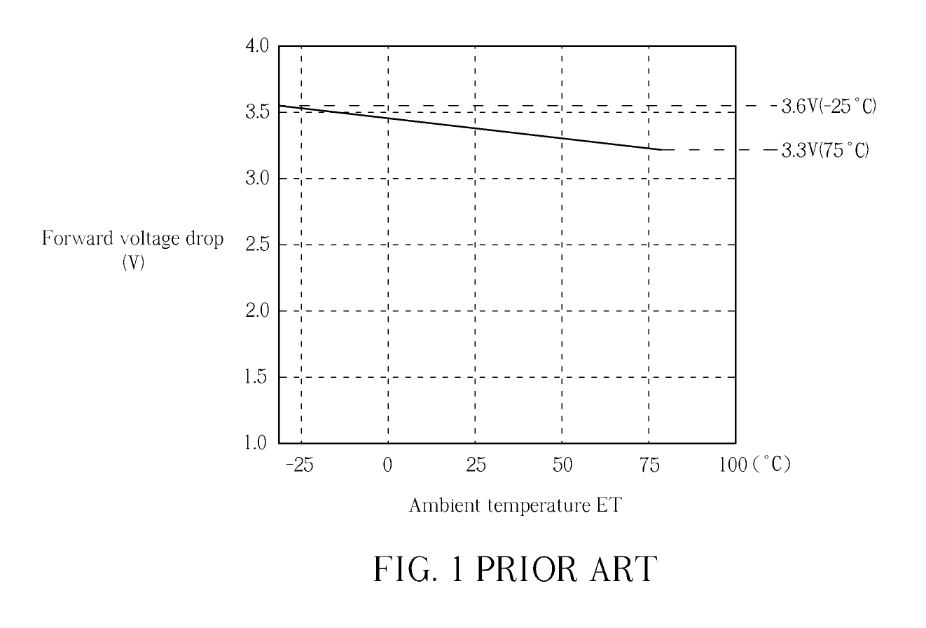

FIG. 2 is a diagram illustrating a driving circuit of light emitting diodes according to the prior art.

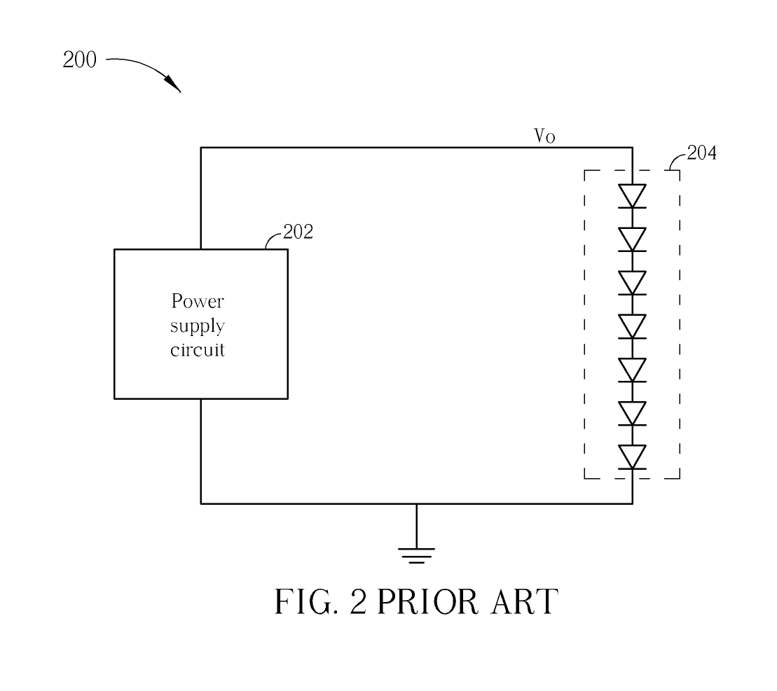

FIG. 3 is a diagram illustrating a driving circuit of light emitting diodes having at least one bypass circuit according to an embodiment.

FIG. 4 is a diagram illustrating a driving circuit of light emitting diodes having at least one bypass circuit according to another embodiment.

FIG. 5 is a diagram illustrating a driving circuit of light emitting diodes having at least one bypass circuit according to another embodiment.

FIG. 6 is a diagram illustrating a driving circuit of light emitting diodes having at least one bypass circuit according to another embodiment.

FIG. 7 is a flowchart illustrating a driving method for controlling at least one bypass circuit of a driving circuit of light emitting diodes according to another embodiment.

FIG. 8 is a flowchart illustrating a driving method for controlling at least one bypass circuit of a driving circuit of light emitting diodes according to another embodiment.

### DETAILED DESCRIPTION

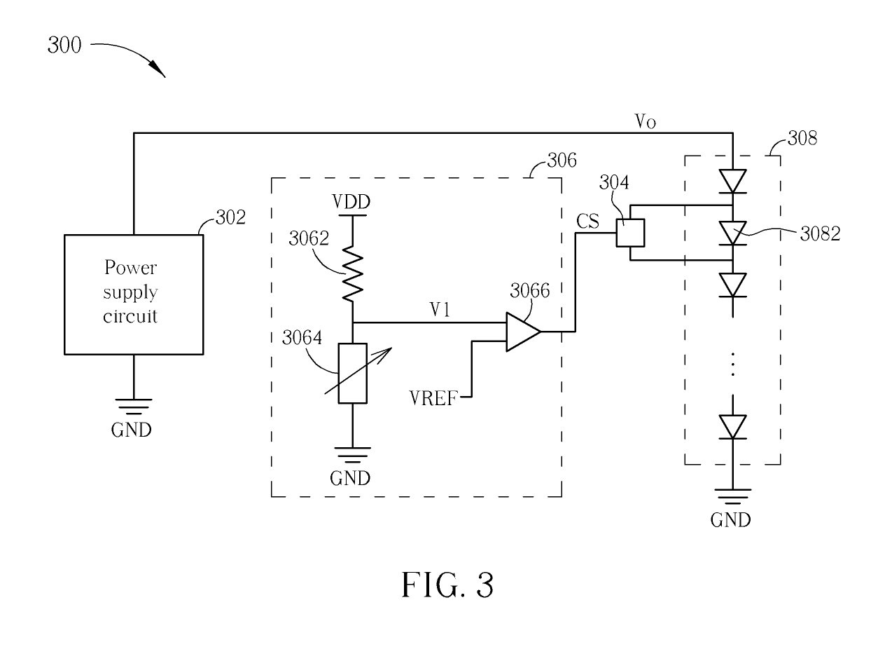

Please refer to FIG. 3. FIG. 3 is a diagram illustrating a driving circuit 300 of light emitting diodes having at least one bypass circuit according to an embodiment. The driving circuit 300 includes a power supply circuit 302, a bypass circuit 304, and a temperature control circuit 306. The power supply circuit 302 is used for providing a driving voltage Vo to a series of light emitting diodes 308, where the series of light emitting diodes 308 includes a plurality of light emitting diodes which are connected in series. The power supply circuit 302 can be a Buck converter, or the power supply circuit 302 can be a Boost/Buck converter, a Cuk converter, a Sepic converter, a Zeta converter, a Flyback converter, a Forward converter, a Push-Pull converter, a Half-Bridge converter, or a Full-Bridge converter. But, the present invention is not limited to the driving voltage Vo being provided to the series of light emitting diodes 308, and not limited to the series of light emitting diodes 308 being coupled to the bypass circuit 304 in parallel. The bypass circuit 304 is used for being turned on when ambient temperature ET is lower than a predetermined temperature T, where the bypass circuit 304 is an N-type metal-oxide-semiconductor transistor, a P-type metal-oxide-semiconductor transistor, or a transmission gate. In addition, the present invention is not limited to only a light emitting diode 3082 being coupled between two terminals of the bypass circuit 304. The temperature control circuit 306 is coupled to the bypass circuit 304 for detecting the ambient temperature ET, and sending a control signal CS to the bypass circuit 304 when the ambient temperature ET is lower than the predetermined temperature T.

The temperature control circuit 306 includes a divider resistor 3062, a thermistor 3064, and a comparator 3066. The divider resistor 3062 has a first terminal for receiving a first voltage VDD, and a second terminal. The thermistor 3064 has a first terminal coupled to the second terminal of the divider resistor 3062, and a second terminal coupled to ground GND. The comparator 3066 has a first input terminal coupled to the second terminal of the divider resistor 3062, a second input terminal for receiving a reference voltage VREF, and an output terminal for outputting the control signal CS. When the ambient temperature ET is equal to 25° C., the thermistor 3064 has a smaller resistance, so a voltage V1 of the first input terminal of the comparator 3066 is lower than the reference voltage VREF. Meanwhile, the bypass circuit 304 is turned off and all light emitting diodes of the series of light emitting diodes 308 are turned on according to the control signal CS. When the ambient temperature ET is equal to −40° C., the thermistor 3064 has a larger resistance, so the voltage V1 is higher than the reference voltage VREF. Meanwhile, the bypass circuit 304 is turned on according to the control signal CS. Therefore, the driving voltage Vo still keeps a plurality of light emitting diodes not coupled to the bypass circuit 304 in parallel turned on, and keeps the light emitting diode 3082 coupled to the bypass circuit 304 in parallel turned off. In addition, after the bypass circuit 304 is turned on, the ambient temperature ET can be gradually increased due to turning-off of the series of light emitting diodes 308, resulting in the voltage V1 being reduced to be lower than the reference voltage VREF. Meanwhile, the bypass circuit 304 is turned off again according to the control signal CS. But, the present invention is not limited to the bypass circuit 304 being turned off according to the control signal CS when the voltage V1 of the first input terminal of the comparator 3066 is lower than the reference voltage VREF, and the bypass circuit 304 being turned on according to the control signal CS when the voltage V1 of the first input terminal of the comparator 3066 is higher than the reference voltage VREF. That is to say, the bypass circuit 304 can also be turned off according to the control signal CS when the voltage V1 of the first input terminal of the comparator 3066 is higher than the reference voltage VREF, and the bypass circuit 304 can also be turned on according to the control signal CS when the voltage V1 of the first input terminal of the comparator 3066 is lower than the reference voltage VREF. Therefore, any configuration in which the bypass circuit 304 is turned on when the ambient temperature ET is lower than the predetermined temperature T, and the bypass circuit 304 is turned off when the ambient temperature ET is higher than the predetermined temperature T falls within the scope of the present invention. In addition, the present invention is also not limited to the ambient temperature ET being 25° C. and −40° C.

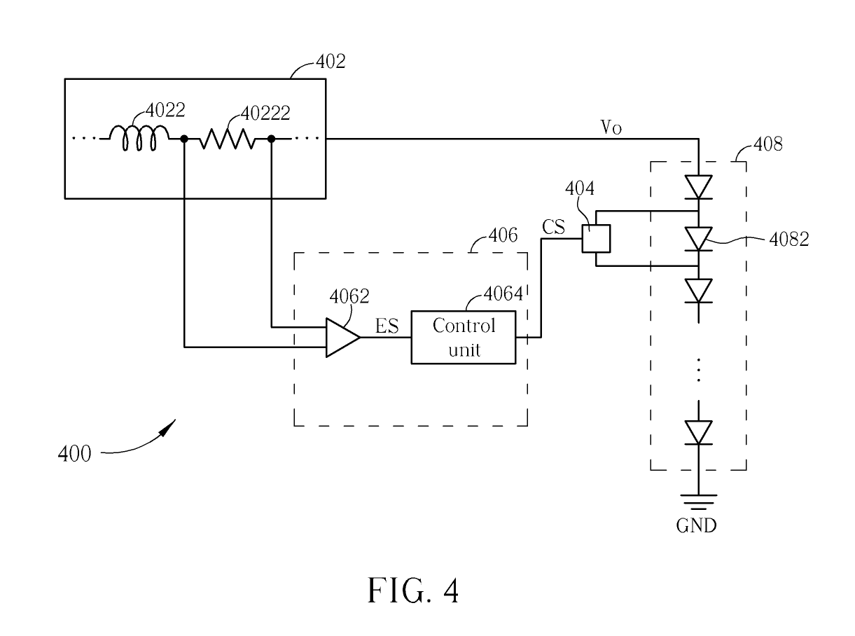

Please refer to FIG. 4. FIG. 4 is a diagram illustrating a driving circuit 400 of light emitting diodes having at least one bypass circuit according to another embodiment. The driving circuit 400 includes a power supply circuit 402, a bypass circuit 404, and a temperature control circuit 406. The temperature control circuit 406 includes a comparator 4062, and a control unit 4064. The comparator 4062 is used for detecting a voltage drop VD generated by a direct current resistance 40222 of an inductor 4022 of the power supply circuit 402. The comparator 4062 outputs an enable signal ES according to the voltage drop VD and a predetermined value. The control unit 4064 is used for receiving the enable signal ES, and outputs a control signal CS to turn on the bypass circuit 404 according to the enable signal ES. In addition, the present invention is not limited to only a light emitting diode 4082 being coupled between two terminals of the bypass circuit 404. When the ambient temperature ET is equal to 25° C., the voltage drop VD generated by the direct current resistance 40222 of the inductor 4022 is larger than the predetermined value, so the comparator 4062 does not output the enable signal ES to the control unit 4064. Meanwhile, bypass circuit 404 is turned off and all light emitting diodes of the series of light emitting diodes 408 are turned on. When the ambient temperature ET is equal to −40° C., the voltage drop VD generated by the direct current resistance 40222 of the inductor 4022 is smaller than the predetermined value, so the comparator 4062 outputs the enable signal ES to the control unit 4064, resulting in the bypass circuit 404 being turned on. Meanwhile, the driving voltage Vo is still larger than a voltage drop of the series of light emitting diodes 408, and the light emitting diode 4082 of the series of light emitting diodes 408 is turned off. But, the present invention is not limited to the comparator 4062 not outputting the enable signal ES when the voltage drop VD is larger than the predetermined value, and the comparator 4062 outputting the enable signal ES when the voltage drop VD is smaller than the predetermined value. That is to say, the comparator 4062 can also output the enable signal ES when the voltage drop VD is larger than the predetermined value, and the comparator 4062 can also not output the enable signal ES when the voltage drop VD is smaller than the predetermined value. Therefore, any configuration in which the bypass circuit 404 is turned on when the ambient temperature ET is lower than the predetermined temperature T, and the bypass circuit 404 is turned off when the ambient temperature ET is higher than the predetermined temperature T falls within the scope of the present invention. In addition, subsequent operational principles of the power supply circuit 402, the bypass circuit 404, and the series of light emitting diodes 408 are the same as those of the power supply circuit 302, the bypass circuit 304, and the series of light emitting diodes 308, so further description thereof is omitted for simplicity. In addition, the present invention is not limited to the series of light emitting diodes 408 being only coupled to one bypass circuit 404 in parallel, and is not limited to the ambient temperature ET being 25° C. and −40° C.

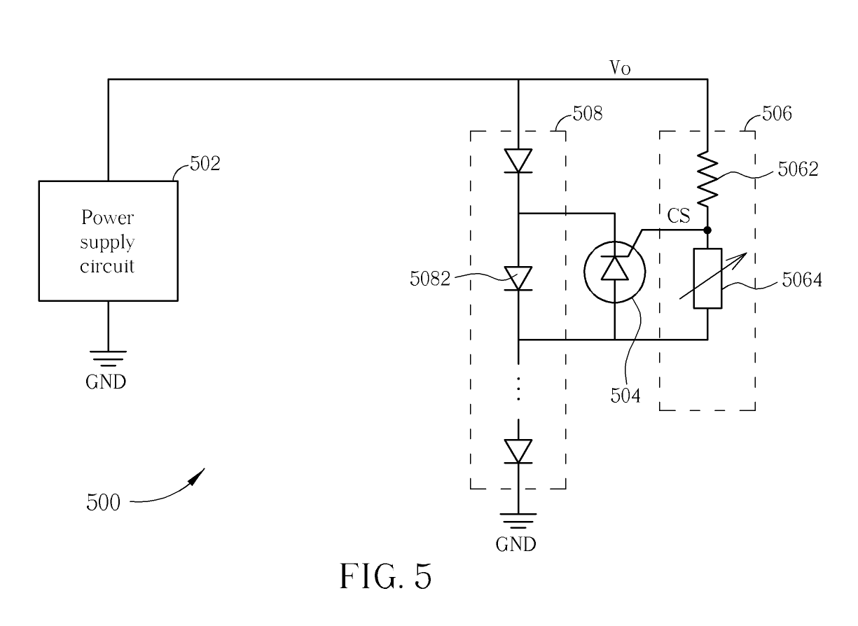

Please refer to FIG. 5. FIG. 5 is a diagram illustrating a driving circuit 500 of light emitting diodes having at least one bypass circuit according to another embodiment. The driving circuit 500 includes a power supply circuit 502, a bypass circuit 504, and a temperature control circuit 506. The temperature control circuit 506 includes a divider resistor 5062, and a thermistor 5064, where a control signal CS is a voltage of a first terminal of the thermistor 5064. The divider resistor 5062 has a first terminal for receiving a driving voltage Vo, and a second terminal. The thermistor 5064 has a first terminal coupled to the second terminal of the divider resistor 5062, and a second terminal. The bypass circuit 504 is a silicon-controlled rectifier (SCR). The bypass circuit 504 has a first terminal coupled to the second terminal of the divider resistor 5062, a second terminal coupled to the second terminal of the thermistor 5064, and a third terminal. In addition, the present invention is not limited to only a light emitting diode 5082 being coupled between two terminals of the bypass circuit 504. When the ambient temperature ET is equal to 25° C., the thermistor 5064 has a smaller resistance, so a voltage of the first input terminal of the thermistor 5064 is smaller, resulting in the bypass circuit 504 being turned off. Meanwhile, all light emitting diodes of a series of light emitting diodes 508 are turned on. When the ambient temperature ET is equal to −40° C., the thermistor 5064 has a larger resistance, so the voltage of the first input terminal of the thermistor 5064 is larger, resulting in the bypass circuit 504 being turned on. Meanwhile, the light emitting diode 5082 of the series of light emitting diodes 508 are turned off. Therefore, the driving voltage Vo is still larger than a voltage drop of the series of light emitting diodes 508. But, the present invention is not limited to only the light emitting diode 5082 being coupled to the two terminals of the bypass circuit 504. In addition, subsequent operational principles of the power supply circuit 502 and the series of light emitting diodes 508 are the same as those of the power supply circuit 302 and the series of light emitting diodes 308, so further description thereof is omitted for simplicity. In addition, the present invention is not limited to the series of light emitting diodes 508 being only coupled to one bypass circuit 504 in parallel, and not limited to the ambient temperature ET being 25° C. and −40° C.

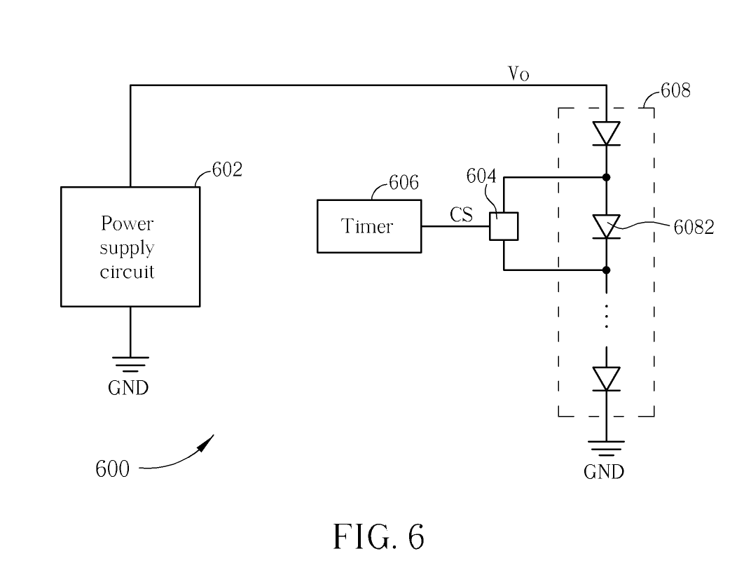

Please refer to FIG. 6. FIG. 6 is a diagram illustrating a driving circuit 600 of light emitting diodes having at least one bypass circuit according to another embodiment. The driving circuit 600 includes a power supply circuit 602, a bypass circuit 604, and a timer 606. The bypass circuit 604 is used for being turned off after the power supply circuit 602 is powered on for a predetermined time PT. After the power supply circuit 602 is powered on for the predetermined time PT, the timer 606 is used for sending a control signal CS to the bypass circuit 604 to turned off the bypass circuit 604, resulting in all light emitting diodes of a series of light emitting diodes 608 being turned on. But, the present invention is not limited to only a light emitting diode 6082 being coupled between two terminals of the bypass circuit 604, and not limited to the series of light emitting diodes 608 being only coupled to one bypass circuit 604 in parallel. In addition, subsequent operational principles of the power supply circuit 602, the bypass circuit 604, and the series of light emitting diodes 608 are the same as those of the power supply circuit 302, the bypass circuit 304, and the series of light emitting diodes 308, so further description thereof is omitted for simplicity.

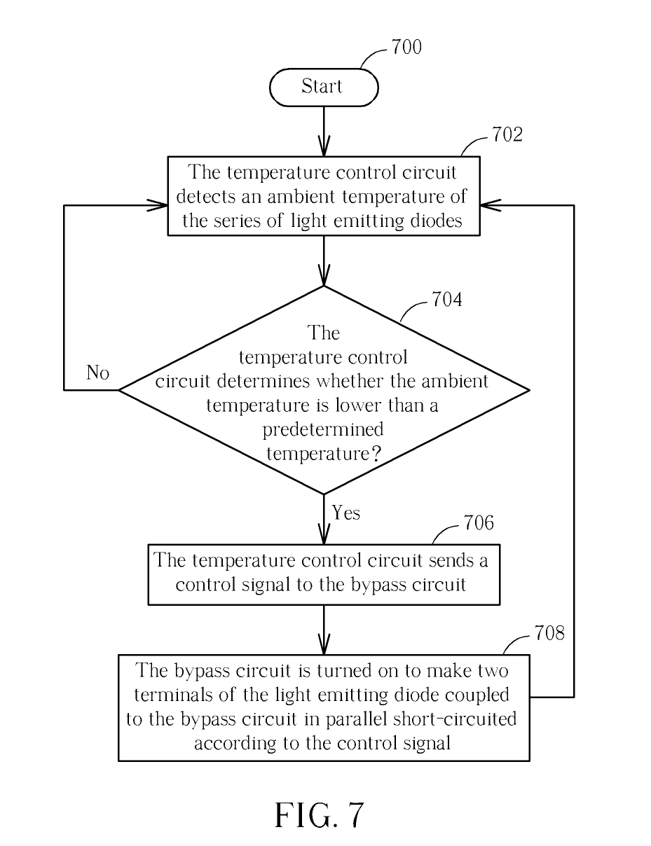

Please refer to FIG. 7. FIG. 7 is a flowchart illustrating a driving method for controlling at least one bypass circuit of a driving circuit of light emitting diodes according to another embodiment. The method in FIG. 7 is illustrated using the driving circuit 300 in FIG. 3. Detailed steps are as follows:

Step 700: Start.

Step 702: The temperature control circuit 306 detects an ambient temperature ET of the series of light emitting diodes 308.

Step 704: The temperature control circuit 306 determines whether the ambient temperature ET is lower than a predetermined temperature T; if yes, go to Step 706; if no, go to Step 702.

Step 706: The temperature control circuit 306 sends a control signal CS to the bypass circuit 304.

Step 708: The bypass circuit 304 is turned on to make two terminals of the light emitting diode 3082 coupled to the bypass circuit 304 in parallel short-circuited according to the control signal CS; go to Step 702.

In Step 706, the temperature control circuit 306 is not limited to the temperature control circuit 306 sending the control signal CS to the bypass circuit 304 when the ambient temperature ET is lower than the predetermined temperature T. Therefore, any configuration in which the bypass circuit 304 is turned on when the ambient temperature ET is lower than the predetermined temperature T, and the bypass circuit 304 is turned off when the ambient temperature ET is higher than the predetermined temperature T falls within the scope of the present invention. But, the present invention is not limited to the series of light emitting diodes 308 being only coupled to one bypass circuit 304 in parallel. In Step 708, the bypass circuit 304 is turned on according to the control signal CS, so the two terminals of the light emitting diode 3082 are short-circuited, resulting in the light emitting diode 3082 being turned off. But, the present invention is not limited to only the light emitting diode 3082 being coupled between the two terminals of the bypass circuit 304.

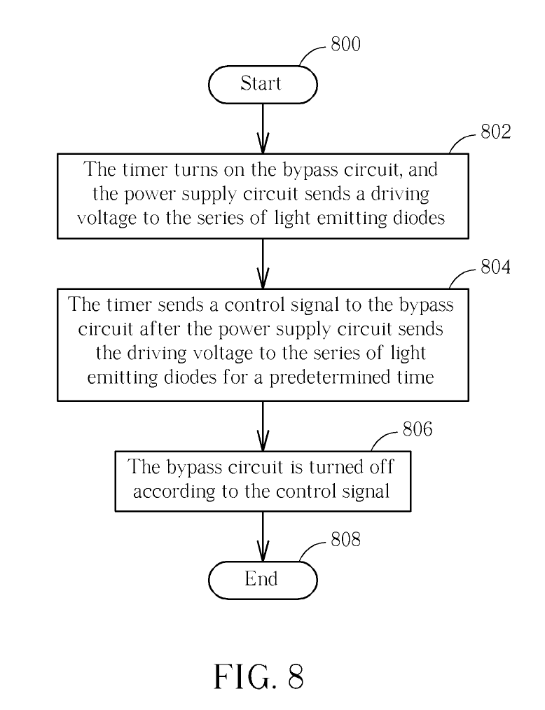

Please refer to FIG. 8. FIG. 8 is a flowchart illustrating a driving method for controlling at least one bypass circuit of a driving circuit of light emitting diodes according to another embodiment. The method in FIG. 8 is illustrated using the driving circuit 600 in FIG. 6. Detailed steps are as follows:

Step 800: Start.

Step 802: The timer 606 turns on the bypass circuit 604, and the power supply circuit 602 sends a driving voltage Vo to the series of light emitting diodes 608.

Step 804: The timer 606 sends a control signal CS to the bypass circuit 604 after the power supply circuit 602 sends the driving voltage Vo to the series of light emitting diodes 608 for a predetermined time PT.

Step 806: The bypass circuit 604 is turned off according to the control signal CS.

Step 808: End.

In Step 802, when the power supply circuit 602 starts to provide the driving voltage Vo to the series of light emitting diodes 608, the bypass circuit 604 is turned on. In Step 806, after the power supply circuit 602 sends the driving voltage Vo to the series of light emitting diodes 608 for the predetermined time PT, the bypass circuit 604 is turned off according to the control signal CS sent by the timer 606. Meanwhile, two terminals of light emitting diode 6082 of the series of light emitting diodes 608 are not short-circuited, resulting in all light emitting diodes of the series of light emitting diodes 608 being turned on. But, the present invention is not limited to the series of light emitting diodes 608 being only coupled to one bypass circuit 604 in parallel, and not limited to only the light emitting diode 6082 being coupled between the two terminals of the bypass circuit 604.

To sum up, the driving circuit of light emitting diodes having at least one bypass circuit and the driving method thereof utilize the temperature control circuit to send a control signal to turn on at least one bypass circuit, resulting in at least one light emitting diode of a series of light emitting diodes being turned off, or utilize the timer to send a control signal to turn off at least one bypass circuit, resulting in at least one light emitting diode of the series of light emitting diodes being turned on. Therefore, when the ambient temperature is lower than the predetermined temperature, a driving voltage provided by the power supply circuit can still drive the series of light emitting diodes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit of light emitting diodes having at least one bypass circuit, the driving circuit comprising:
a power supply circuit for providing a driving voltage to at least one series of light emitting diodes;
at least one bypass circuit, each bypass circuit of the at least one bypass circuit being used for being turned on when an ambient temperature is lower than a predetermined temperature; and
a temperature control circuit coupled to the at least one bypass circuit for detecting the ambient temperature, and sending a control signal to the at least one bypass circuit when the ambient temperature is lower than the predetermined temperature.

2. The driving circuit of claim 1, wherein the power supply circuit is a Buck converter.

3. The driving circuit of claim 1, wherein the power supply circuit is a Boost/Buck converter.

4. The driving circuit of claim 1, wherein the bypass circuit is an N-type metal-oxide-semiconductor transistor.

5. The driving circuit of claim 1, wherein the bypass circuit is a P-type metal-oxide-semiconductor transistor.

6. The driving circuit of claim 1, wherein the bypass circuit is a transmission gate.

7. The driving circuit of claim 1, wherein the temperature control circuit comprises:
a divider resistor having a first terminal for receiving a first voltage, and a second terminal;
a thermistor having a first terminal coupled to the second terminal of the divider resistor, and a second terminal coupled to ground; and
a comparator having a first input terminal coupled to the second terminal of the divider resistor, a second input terminal for receiving a reference voltage, and an output terminal for outputting the control signal, wherein the comparator outputs the control signal according to a voltage of the first input terminal of the comparator and the reference voltage.

8. The driving circuit of claim 1, wherein the temperature control circuit comprises:
a comparator for detecting a voltage drop generated by a direct current resistance of an inductor of the power supply circuit, and outputting an enable signal according to the voltage drop and a predetermined value; and
a control unit for outputting the control signal when the control unit receives the enable signal.

9. The driving circuit of claim 1, wherein the temperature control circuit comprises:
a divider resistor having a first terminal for receiving the driving voltage, and a second terminal; and
a thermistor having a first terminal coupled to the second terminal of the divider resistor, and a second terminal;
wherein the control signal is a voltage of the first terminal of the thermistor.

10. The driving circuit of claim 9, wherein the bypass circuit is a silicon-controlled rectifier (SCR), wherein the silicon-controlled rectifier has a first terminal coupled to the second terminal of the divider resistor, a second terminal coupled to the second terminal of the thermistor, and a third terminal, wherein at least one light emitting diode is coupled between the second terminal and the third terminal of the silicon-controlled rectifier.

11. The driving circuit of claim 1, wherein each series of light emitting diodes of the at least one series of light emitting diodes is coupled to at least one bypass circuit in parallel.

12. A driving method for controlling at least one bypass circuit of a driving circuit of light emitting diodes, the driving method comprising:
detecting an ambient temperature of a series of light emitting diodes;
determining whether the ambient temperature is lower than a predetermined temperature;
sending a control signal when the ambient temperature is lower than the predetermined temperature; and
turning on at least one bypass circuit to make two terminals of at least one light emitting diode of the series of light emitting diodes short-circuited according to the control signal.

13. The driving method of claim 12, further comprising:
turning off the at least one bypass circuit when the ambient temperature is higher than the predetermined temperature.

14. A driving circuit of light emitting diodes having at least one bypass circuit, the driving circuit comprising:
a power supply circuit for providing a driving voltage to at least one series of light emitting diodes;
at least one bypass circuit, each bypass circuit of the at least one bypass circuit being used for being turned off after the power supply circuit is powered on for a predetermined time; and
a timer for sending a control signal to the at least one bypass circuit to turn off the at least one bypass circuit after the power supply circuit is powered on for the predetermined time.

15. The driving circuit of claim 14, wherein each series of light emitting diodes of the at least one series of light emitting diodes is coupled to at least one bypass circuit in parallel.

16. A driving method for controlling at least one bypass circuit of a driving circuit of light emitting diodes, the driving method comprising:
providing a driving voltage to a series of light emitting diodes;
sending a control signal to at least one bypass circuit after the driving voltage is provided to the series of light emitting diodes for a predetermined time; and
turning off the at least one bypass circuit according to the control signal.
